(19) United States
(12) Patent Application Publication
(10) Pub. No.: US 2003/0208401 A1
(43) Pub. Date: Nov. 6, 2003

(54) Online contracting for marketing

(76) Inventor: Colin Karsten, Avon, CT (US)

Correspondence Address: Joseph P Kincart, Clifford Chance, 200 Park Avenue, New York, NY, 10016, US

(21) Appl. No.: 10/297,960

(22) PCT Filed: Jun. 12, 2001
(86) PCT No.: PCT/US01/18877

(30) Foreign Application Priority Data
Jun. 12, 2000 (US) 09591806

(51) Int. Cl. G06F 17/60

(52) U.S. Cl. 705/14

(57) ABSTRACT

A method and system for an allocation system that sells marketing over geographically delineated units using a computer communications network. Merchants can use computer servers to set up an automated online allocation system that allows potential marketers to buy or lease marketing rights for geographical areas. The individual units are assigned to a marketer, who begins advertising the online site. The merchant pays a commission to the marketer based on sales in the marketer's unit.

### CROSS REFERENCED TO RELATED APPLICATIONS

This application claims priority to U.S. application Ser. No. 09/591,806 filed Jun. 12, 2000 entitled “Online Contracting for Marketing”.

### BACKGROUND

The Internet's growth over the past decade has led to a substantial increase in the number of web sites available for browsing and commerce amongst other uses. Web sites have been used for selling merchandise and services to customers world-wide. In order to increase sales, operators of web sites often seek to increase the number of people who view their site. This is also known as increasing the number of “eyeballs” or “hits.” Most web sites take a general approach to marketing, a kind of “shotgun” approach, which relies on a small percentages of the people being targeted ever actually eyeballing the site.

There are varieties of marketing methods that a web site can use to advertise in an attempt to get eyeballs. One of the most popular methods is through linking. Linking consists of placing a text or graphical link to the advertised web site on another web site. A user viewing the second web site can click the link and be routed to the advertised web site. In exchange for the link, the second web site might require that the first web site link back to it. In this method, known as link exchange, both sites benefit from the links advertising the other web site.

In a second method known as banner advertising, the second web site may require that the first web site pay to place a link on its web page. Banner advertisements are quite popular on the Internet and many sites solely derive revenue from such advertisements.

A third method for marketing a web site is through e-mail. E-mail marketing consists of sending solicited or unsolicited e-mails to a list of recipients who are likely visitors of the marketed web site. Contained in the e-mail is a link to the web site. If the recipient is interested in the service or web site, then she need only click the link to visit the site.

Traditional methods have also been used to advertise web sites. Traditional advertising includes advertising on such media as print, billboards, radio, or television. For example, a web site owner might place an advertisement for its site in a magazine or in a commercial on television. If a consumer is interested in the advertised web site, then she need only enter the URL address of the web site the next time she is browsing the Internet. Most forms of traditional advertising are targeted at a local audience. The Internet caters to a national or even international audience. A web site that has its servers in New York is accessible by persons from New York, Calif., and any other place that has an Internet connection, even locations in different countries. Because of the vast local territory that the Internet covers, it is difficult for one company to direct local advertising to all audiences that might be interested in its web site.

Furthermore, while these marketing methods have been successful in promoting web sites, the online world, whether on the Internet or other computer communication networks, has not connected direct sales one-on-one marketing processes to the online medium. Most marketing takes place across a broad geographical audience. With such an audience, web sites cannot market to the needs and desires of local consumers.

What is needed is a system and method for localizing responsibilities associated with marketing and for rewarding successful marketing efforts with increased compensation. In this manner a local marketer that is successful in bringing sales to an Internet web site can receive commensurate compensation.

### SUMMARY

Accordingly, the present invention provides a method and apparatus for a system that allocates marketing over geographically delineated units and tracks sales received from each unit using a computer communications network. In addition, merchants can use an application program operating on a computer server to provide an automated online system that allocates marketing rights for geographical areas to potential marketers.

In one embodiment, the invention includes a computer-implemented method for providing online allocation between a merchant and a marketer for marketing rights to a geographical area. This method involves dividing a geographical area into individual units, such as, for example, the United States divided by zip code. The system can transmit a form containing available units over a computer communication network. One or more individual units can be allocated to a marketer. The marketer can be granted exclusive or non-exclusive marketing rights relating to the merchant for each area allocated to the marketer. The merchant can then be required to pay a commission, or otherwise compensate the marketer, based upon sales originating from within the marketer's geographic unit.

In another embodiment, the invention assigns individual units to a marketer by selling each individual unit to a marketer. The price can either be a fixed price, or set by auction or reverse auction. The system can administer the auction for the merchant. A fixed price can be calculated based on factors, such as population, income, housing costs, and accessibility. Geographical units can be delineated by various types of geographic area, including zip codes, area codes, states, regions, precincts, counties, and countries.

This invention may be embodied in a computer system, which provides marketing for an online site. The system can include a computer server accessible via a computer communications network. Executable software residing in a server memory can be operative with a processor to divide a geographical area into individual units and transmit it over a computer communications network. The software can also assign each individual unit to a marketer, who then advertises the online site. Finally, the software may also pay a commission to the marketer based on sales in the marketer's geographical unit.

In another embodiment, the software can be executable on demand via a network access device, such as a computer. For example, a computer accessing the Internet or other communication network conforming to the transmission control protocol/internet protocol, such as an intranet, can use a web interface for accessing the executable software stored on a server storage medium.

The invention can be embodied by a computer data signal in a digital data stream. The computer data signal can be generated to divide a geographical area into individual units and transmit the units over a computer network. The signal can also assign each individual unit to a marketer, who advertises the online site. Finally, the signal can also arrange for a payment of a commission to the marketer based on sales in the marketer's unit. For example, the computer data signal generated can adhere to the transmission control protocol/internet protocol.

The details of one or more embodiments of the invention are set forth in the accompanying drawings and the description below. Implementations may provide one or more of the following advantages. The online allocation system may improve the number of hits an online site receives by marketing directly to a local audience. Online sites may have an easier time finding local marketers willing to market its web site because the marketer has access to important marketing data that can allow the marketer to decide whether to market the site. Furthermore, because the marketing data is kept on-line, the marketer and merchant can have access to geographic data, socioeconomic data, population data, sales information, and other pertinent data that might be useful in marketing the web site.

### DESCRIPTION OF THE DRAWINGS

FIG. 1 illustrates a flowchart of the business method and process.

FIG. 2 illustrates a network diagram of the online marketing system.

FIG. 3 illustrates a screenshot of a geographic marketing territory application depicting demographic and pricing information.

FIG. 4 illustrates a screenshot of a geographic territory example depicting postal code territories.

### DETAILED DESCRIPTION

This invention relates to a method and system for marketing relating to sales and services. In particular, the present invention relates to a system that allocates marketing territories over geographically delineated units and tracks sales using a computer communications network.

A computer communications system can provide a vehicle for an allocation system that provides, such as through a sale or lease, geographically delineated units to marketers. A marketer can use a network access device, such as a computer, to view available geographic areas and contract with a merchant via the network to obtain marketing rights for a desired area. When the merchant makes a sale, she pays a commission to the marketer associated with the geographical area of the sale. In alternate embodiments, the geographical area can be determined as the area from which an order originated or an area to which an order is shipped

This invention merges marketing models from two distinct areas. The first is the online environment, such as web sites on the Internet. The second is direct sales or one-to-one marketing. The invention is a method or system by which a business or other entity assigns an individual or group to promote its online site within a specific geographical area in exchange for a commission. The allocation system exists entirely online, with the actual marketing or promoting taking place mostly offline, within the realm of traditional marketing models.

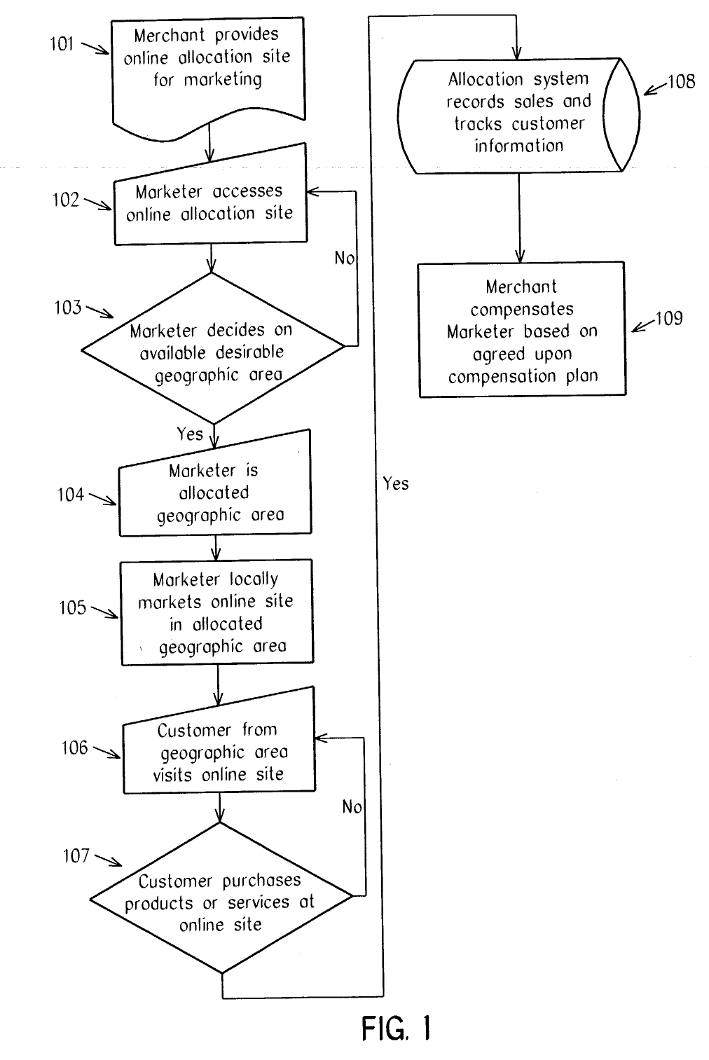

Referring now to FIG. 1, a method for using a computer communications network to create an online allocation system for marketing is described. A merchant, who has an online presence, sets up an online allocation site for marketing 101. The system may be located on the merchant's own system or may be located on the system of an online allocation provider. Marketers then access the online allocation site and view its data to determine if they should acquire a geographic area 102. The marketer may also visit the merchant's online site to view the merchandise or services first-hand. Once a marketer decides to acquire a geographic unit 103, the system allocates the geographic area to the marketer 104. This allocation may occur after the marketer signs an online contract with the merchant or online allocation system. The contract may call for the marketer to acquire the geographic unit by, for example, purchasing it or leasing it. The marketer then begins to market locally the merchant's online site in the assigned geographic area 105. Customers from the geographic area that the marketer acquires visit the online site 106. If a customer makes a purchase from the site 107, then the allocation system records the sales and tracks the customer's information 108. The merchant then compensates the marketer in the assigned geographic area of the customer 109. This compensation can be based on a variety of factors, such as the number of sales in the marketer's geographic area or a set percentage for each sale.

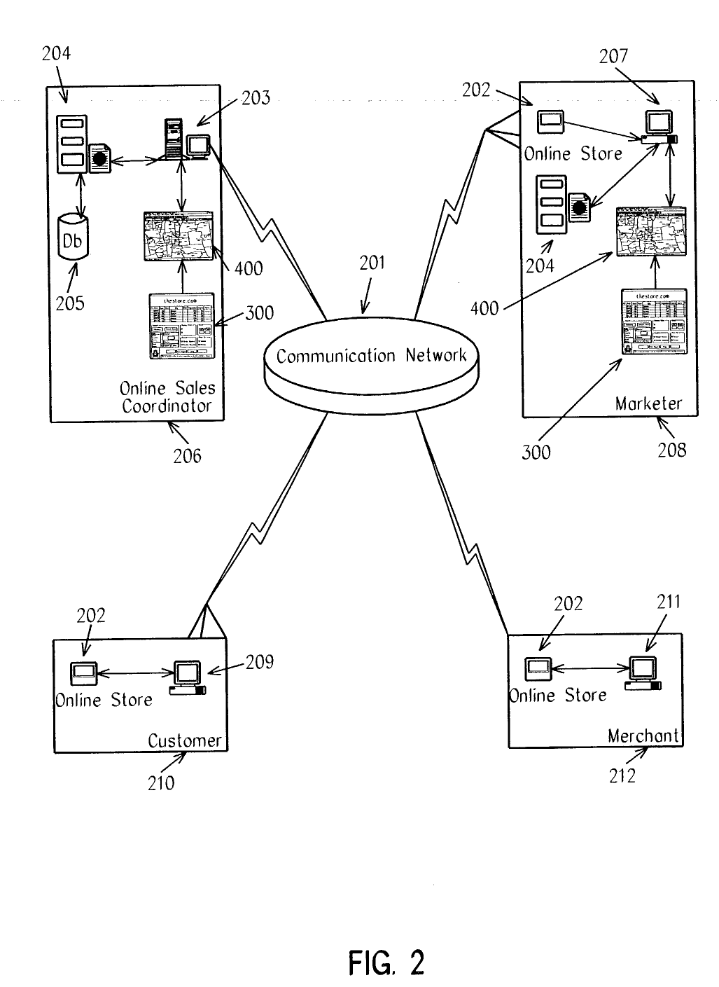

FIG. 2 shows a network diagram of the online allocation system. The online allocation system for marketing can include a communications network 201. Communications are sent between the online sales coordinator's server 203, the merchant's server 211, the marketers' terminals 207, and the customers' terminals 209. This network 201 may consist of an Intranet, an Internet, a local LAN or WAN, or any other type of network system that would allow signals to pass between computers, including a combination of network systems. The online sales coordinator's server 203, the merchant's server 211, the marketers' terminals 207, and the customers' terminals 209 all have access to the network 201.

To begin, the merchant 212 provides an online store 202 on a computer 211 and allows others to view it via the network 201. The merchant 212 may host the online store 202 locally or may have an outside site host the online store 202. The merchant 212 also provides an online allocating system for marketing 206. The merchant 212 may host the online allocation system for marketing 206 locally or may have an outside site, such as an online sales coordinator company, host the site. The online system should allow marketers to view the online allocating system for marketing via the network 201. The system 206 has access to a database 205, which contains information about the online store's 202 actual and potential customers, how the geographical units are delineated, specific information on each geographic unit, such as population, average income, and number of current customers. The database 205 may store data in a database format, a spreadsheet format, or any other format for easy retrieval. The information included in the system 206 is viewable by potential marketers 208.

A marketer 208 uses her computer 207 to view the merchant's online allocation system for marketing 204 via the communications network 201. The marketer 208 may also view the merchant's online store 202. To research the marketing opportunities, the marketer 208 reviews the merchant's marketing site 300, which includes a listing of available local locations that need marketers 400. The marketer 208 uses this information to decide on desirable geographical units. The online sales coordinator 206 allocates to the marketer 208 the rights to market in the chosen geographical location via the online connection 201. This may be accomplished by the marketer 208 signing a contract with the merchant 212 over an online connection 201. The signing of the contract may not require any interaction outside filling in the online forms. The system 206 may allocate different geographic units to many marketers 208.

The marketer 208 then markets the merchant's site within her allocated geographic area through traditional or nontraditional marketing methods. Customers 210 from the allocated geographic unit can visit the online store 202 with their computer 209. The shipping address or billing address of the customer 210 may define the customer's geographical area for commission purposes. If the customer 210 decides to purchase a product or service from the online store 202, then the system 206 can pay a commission to the marketer 208 who is allocated the customer's geographical unit. The merchant may pay the commission electronically, via mail, or any other convenient payment system. The commission may be calculated based on a percentage per sale, threshold amounts, such as a set fee for 1-100 sales and a different fee for 101-1000 sales, or any other compensation arrangement amenable to both parties. The marketer may decide on the commission when she is allocated the geographic area, with some types of commissions perhaps costing more in purchase or lease fees. The merchant 212 then ships the goods or provides services to the customer 210 and the sale is complete. This provides an incentive for marketers 208 to market the merchant's products and services within their designated geographical area. The more customers that purchase products or services from the merchant's store that originate from a location that the marketer owns or leases, the more commission the marketer can collect from the merchant. All shopping, paying, contracting, and shipping can be handled by an automated device.

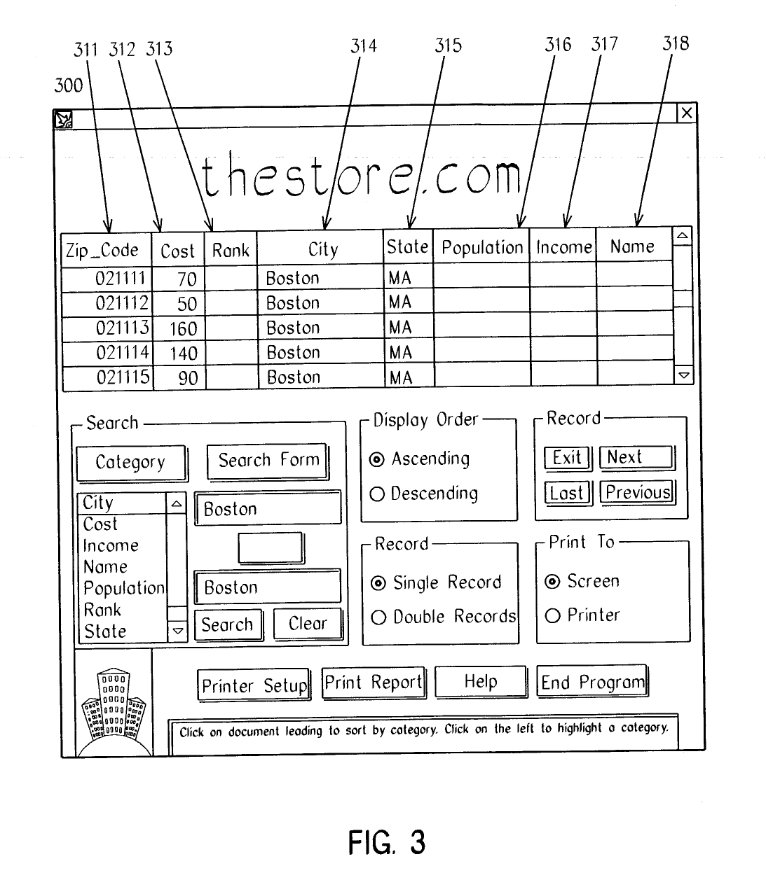

FIG. 3 illustrates an example of a geographical sale web page 300. A marketer viewing this web page would be able to analyze different geographical areas to decide which they are interested in pursuing. This web page contains a table that shows available geographical areas. The areas are divided by zip code 311, and marketing information is given for each area, including the name of the city 314, the state 315, the population of the area 316, and the average income of its residents 317. The price of the area 312 is also included in the table. Once the system allocates an area, the marketer's name is inserted in the name column 318 to indicate that the area is not available. The marketer or merchant can perform various queries on this table, including searches based on city, cost, income, name, population, rank, state, and zip code.

A fixed price can be used for the allocation of a geographic area. The fixed price can be calculated based on factors taken from the list of population, income, housing costs, and accessibility. Geographic areas do not have to be delineated only by zip codes. Area codes, states, regions, precincts, counties, or even countries can be used to divide up geographical areas to be sold to local marketers.

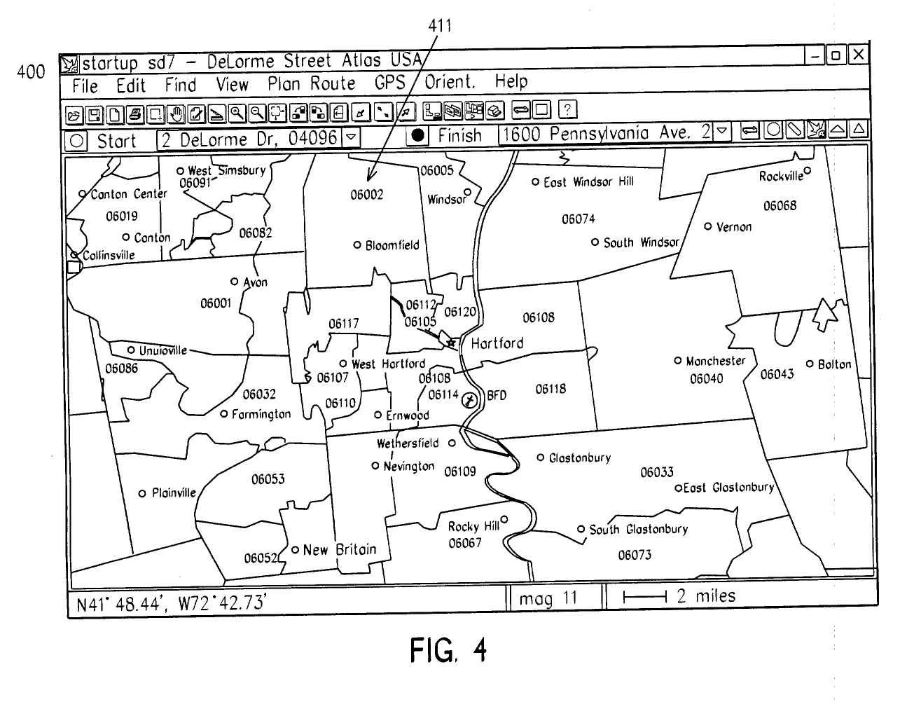

FIG. 4 shows an example of a zip code based map that can be used in conjunction with the web page 300 to help the marketer or merchant pinpoint particular areas of interest. The map 400 contains possible marketing areas delineated by zip code. The merchant or marketer can use the map for research or selection purposes.

The allocation of geographic areas to marketers need not be indefinite. Depending on the agreement between the marketer and the merchant, the allocation of the geographic area may be for a set period of time, such as three months or one year. The allocation may also be contingent upon a set of conditions, such as the allocation continues as long as a minimum sales threshold is met. These time limits or conditions can be determined by the merchant or may be bargained for before the marketer is allocated the geographic area.

Traditional marketers are not the only people who can benefit from the system. Fundraiser groups, such as girl scouts and local charities, can be allocated the geographic areas for marketing. The merchant can pay a commission to these groups based on their success, which may take into account their charitable status.

The invention may be implemented in digital electronic circuitry or in computer hardware, firmware, software, or in combination of them. Apparatus of the invention may be implemented in a computer program product tangibly embodied in a machine-readable storage device for execution by a programmable processor. Method steps of the invention may be performed by a programmable processor executing a program of instructions to perform functions of the invention by operating on input data and generating output.

The invention may also be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors

Computers 203, 207, and 209, in the automated allocation for marketing system may be connected to each other by one or more network interconnection technologies, as represented by the communications network 201. For example, dial-up lines, token ring or Ethernet networks, T1 lines, asynchronous transfer mode links, wireless links and integrated service digital network (ISDN) connections may all be combined in the network 201. Other packet network and point-to-point interconnection technologies may also be used. Additionally, the functions associated with separate processing and database servers 205 may be integrated into a single server system or may be partitioned among servers and database systems that are distributed over a wide geographic area.

A number of embodiments of the present invention have been described. Nevertheless, it will be understood that various modifications may be made without departing from the spirit and scope of the invention. For example, computers 203, 207, 209, and 211 can comprise a personal computer executing an operating system such as Microsoft Windows™, Unix™, Lynix™, or Apple Mac OS™, as well as software applications, such as a web browser or spreadsheet. Client computers 203, 207, 209, and 211 can also be terminal devices, a palm-type computer. Other examples can include TV Internet Browsers, terminals, and wireless access devices, such as 3-Com Palm organizer. A client computer may include a processor, RAM and/or ROM memory, a display capability, an input device, and a hard disk or other relatively permanent storage. Accordingly, other embodiments are within the scope of the following claims.

What is claimed is:

1. A computer-implemented method for marketing an online site, the method comprising:
dividing a geographical area into a plurality of individual units;
transmitting over a computer communication network a form containing available units;
assigning each individual unit to a marketer, wherein the marketer advertises the online site; and
paying a commission to the marketer based on sales in the marketer's unit.

2. The method of claim 1 wherein assigning each individual unit further comprises selling each individual unit to a marketer.

3. The method of claim 1 wherein assigning each individual unit further comprises leasing each individual unit to a marketer

4. The method of claim 1 wherein assigning the individual unit further comprises pricing the individual units based on an auction.

5. The method of claim 1 wherein assigning the individual unit further comprises pricing the individual units based on a reverse auction.

6. The method of claim 1 wherein assigning the individual unit further comprises pricing the individual units based on factors taken from the list of population, income, housing costs, and accessibility.

7. The method of claim 1 wherein the individual units are delineated by geographic area, taken from the list consisting of zip codes, area codes, states, regions, precincts, counties, and countries.

8. The method of claim 1 wherein the step of paying a commission further comprises:
recording customer information;
calculating a commission, wherein the commission is based on an agreed upon method;
paying the commission to the marketer.

9. The method of claim 1 further comprising:
canceling the allocation based on the expiration of a set period of time.

10. The method of claim 1 further comprising:
canceling the allocation based on a failure of the marketer to meet a condition.

11. A computer system for providing marketing for an online site, the system comprising:
a computer server accessible via a computer communications network, wherein the server comprises a memory and a processor; and
executable software residing in the server memory wherein the software is operative with the processor to:
divide a geographical area into a plurality of individual units;
transmit over a computer communication network a form containing available units;
assign each individual unit to a marketer, wherein the marketer advertises the online site; and
pay a commission to the marketer based on sales in the marketer's unit.

12. The computer system of claim 11 wherein the software is executable on demand via a network access device.

13. The computer system of claim 12 wherein the network access device comprises a computer.

14. The computer system of claim 11 wherein the computer communication network conforms to the transmission control protocol/internet protocol.

15. The computer system of claim 11 additionally comprising a WEB interface for accessing the executable software stored on the server storage medium.

16. A computer data signal embodied in a digital data stream, wherein the computer data signal is generated by a method comprising the steps of:
dividing a geographical area into a plurality of individual units;
transmitting over a computer communication network a form containing available units;
assigning each individual unit to a marketer, wherein the marketer advertises the online site; and
paying a commission to the marketer based on sales in the marketer's unit.

17. A computer data signal as in claim 16 wherein the signal generated adheres to the transmission control protocol/internet protocol.
